(19) United States
(12) Patent Application Publication
(10) Pub. No.: US 2026/0004178 A1
(43) Pub. Date: Jan. 1, 2026

(54) NETWORK ANALYSIS USING OPTICAL QUANTUM COMPUTING

(71) Applicant: HSBC SOFTWARE DEVELOPMENT (GUANGDONG) LIMITED, Guangzhou (CN)

(72) Inventors: Bing ZHU, Guangzhou (CN); Yong XIA, Guangzhou (CN); Ziyuan LI, Guangzhou (CN); Si Yuan JIN, Guangzhou (CN)

(21) Appl. No.: 18/880,544

(22) PCT Filed: Jan. 5, 2023
(86) PCT No.: PCT/CN2023/070773

§ 371 Date: Dec. 31, 2024

(30) Foreign Application Priority Data
Jul. 7, 2022 (CN) 202210803217.0

(51) Int. Cl. G06N 10/60; G06F 16/901

(52) U.S. Cl. CPC G06N 10/60; G06F 16/9024

(57) ABSTRACT

There is described a method of detecting an anomaly in a transaction network using an optical quantum-computing device. The method comprises obtaining transaction information. generating a transaction graph based on the transaction information. encoding inputs of a Gaussian Boson Sampling (GBS) device based on the transaction graph. processing outputs of the GBS device to identify one or more dense subgraphs of the transaction graph. and generating a detection output identifying one or more of the identified dense subgraphs as representative of a potential anomaly. There is also described an apparatus for detecting an anomaly. comprising a GBS device having a photon source. a linear optical interferometer and a photon detector. and a computer device configured to program inputs of the GBS device.

### FIELD OF THE INVENTION

The present invention generally relates to optical quantum computing for network analysis. Specifically, the present invention relates to using a Gaussian Boson Sampling device to identify abnormal network events or interactions, for example in order to identify portions of a transaction network associated with fraudulent or malicious activity.

### BACKGROUND OF THE INVENTION

Many different types of networks, including communications networks, computing networks and transaction networks, are prone to experiencing abnormal or unwanted network events or interactions. Thus, there is typically a need to analyse networks in order to identify and remove the causes of such unwanted events. For example, in transaction networks such as those relying on distributed ledger technology, there is a need to identify fraudulent and/or illegal transactions, while in communication networks, faults or malicious activity need to be dealt with to avoid network congestion and security breaches.

However, as the size and complexity of networks grow, it becomes increasingly difficult to analyse them. Many existing approaches for identifying irregular or unwanted network events do not scale efficiently with network size. In particular, by virtue of their underlying distributed ledger technology (such as a blockchain), some transaction networks can provide a decentralized environment for peer-to-peer (P2P) transactions, which can result in a very large and complex network. It can thus be particularly challenging for authorities, regulators and individual traders or investors to identify abnormal or unwanted activity in such transaction networks, such as so-called “Pump and Dump” and “Wash Trading” strategies whereby the price of a cryptocurrency is artificially manipulated.

Classical computer algorithms for detecting illicit activities such as price manipulation generally compromise between efficiency and accuracy, and the detection often takes an impractically large amount of time due to the huge amount of data available.

### SUMMARY OF THE INVENTION

Aspects of the invention are set out in the independent claims and preferable features are set out in the dependent claims.

The methods disclosed herein map network activity into a complex graph problem that can be solved by a quantum GBS device. To analyse events such as transactions in a transaction network, a transaction graph can be constructed based on the transactions. Price manipulation with the “Pump and Dump” and “Wash Trading” strategies often involves large-volume and high-frequency transactions among a small group of parties, which forms a dense subgraph in such a transaction graph. Identifying such dense subgraphs can thus allow abnormal transaction patterns to be identified. Similarly, graphs can be constructed based on web graphs and social networks, for example to detect link spamming in web search engines, where link spams are websites manipulating the search engine rankings by linking with each other. By using a quantum GBS device, dense subgraphs of an undirected graph can be found efficiently and accurately.

There is disclosed herein a method of detecting an anomaly in a transaction network using a quantum-computing device, comprising:
obtaining transaction information of transactions performed between entities of the network;
generating a transaction graph based on the transaction information;
encoding inputs of a Gaussian Boson Sampling, GBS, device based on the transaction graph;
processing outputs of the GBS device to identify one or more dense subgraphs of the transaction graph; and
generating a detection output identifying one or more of the identified dense subgraph(s) as representative of a potential anomaly.

By encoding inputs of a GBS device based on a transaction graph, dense subgraphs of the transaction graph (corresponding to potential network anomalies) can be identified efficiently and accurately. The described approach can in particular overcome the technical performance limitations of conventional computing systems implementing algorithms for identifying dense subgraphs by providing a novel computing system than incorporates an optical quantum computing component in the form of a GBS device.

Processing outputs of the GBS device may comprise mapping the outputs of the GBS device to vertices of the transaction graph to form subgraphs of the transaction graph. Encoding inputs of the GBS device may comprise generating an adjacency matrix of the transaction graph, and encoding inputs of the GBS device based on the adjacency matrix. The term “adjacency matrix” preferably refers to a matrix representation of the vertices (or nodes) and edges of a graph, where an edge connecting two vertices (forming an “adjacency” in the graph) is encoded as an element of the adjacency matrix. Thus, the adjacency matrix is typically a square matrix with each row/column corresponding to a node of the graph, and each matrix element indicating the presence of an edge between the vertices corresponding to the relevant row and column of that element. Where edges of the graph are weighted, the values of the matrix elements may correspond (e.g. be equal to) the edge weights.

Encoding inputs of the GBS device may further comprise determining a unitary matrix and a diagonal matrix based on the adjacency matrix, and programming the GBS device based on the unitary matrix and diagonal matrix. The unitary matrix and the diagonal matrix may be determined based on a factorization of the adjacency matrix. The factorization may be an Autonne-Takagi factorization.

The GBS device may comprise a linear optical interferometer. The GBS device may further comprise a photon source for supplying photons to the interferometer and a photon detector for detecting photons output by the interferometer. The linear optical interferometer may be configured to scatter photons supplied by the photon source, and the photon detector may be configured to detect the scattered photons.

Programming the GBS device may comprise programming the linear interferometer based on the unitary matrix and/or programming the photon source based on the diagonal matrix. Programming the linear interferometer may include controlling linear interference by programming the reflectivity and/or transmissivity of beam splitters of the linear interferometer using the elements of the unitary matrix. Programming the photon source may include setting squeezing parameters of the photon source based on diagonal elements of the diagonal matrix.

The photon detector may be configured to produce an output comprising a plurality of output signals. Each output signal may be indicative of whether a single photon has been detected. Each output signal may be a binary output signal. Each output signal may correspond to a vertex in the transaction graph. Each output signal may indicate a positive result indicative of detection of a photon or a negative result indicative of absence of a detected photon. For each photon detector output, a combination of the output signals which indicate a positive result may correspond to a subgraph of the transaction graph.

Processing outputs of the GBS device may comprise processing a plurality of outputs over repeated operation of the GBS device, each output identifying a subgraph of the transaction graph. The method may further comprise, for each of a set of possible outputs corresponding to respective subgraphs, estimating a probability of detecting the output based on the plurality of outputs. Identifying one or more dense subgraphs may be based on the estimated probabilities. The probability of detecting an output may be estimated based on the frequency with which the output is observed in the plurality of outputs. A probability of detecting an output and/or a frequency with which an output is observed may be related to a density of the corresponding subgraph.

Identifying one or more dense subgraphs may comprise selecting one or more of the outputs of the GBS device having high estimated probabilities. An estimated probability may be considered to be high in comparison to estimated probabilities of other GBS device outputs, or in comparison to a threshold probability. Identifying one or more dense subgraphs may comprise one or more of: selecting one or more outputs having probabilities exceeding a threshold, and selecting a predetermined number of the outputs which have the highest estimated probabilities. The predetermined number of outputs to be selected may be around 5, 10, 50 or 100. The method may further comprise determining, for each selected output, a corresponding subgraph of the transaction graph to be a dense subgraph.

Generating the transaction graph may comprise: identifying a plurality of transactions based on the transaction information, each transaction indicative of network entities and a transaction value transferred between the network entities; and generating a transaction graph comprising a plurality of vertices based on the network entities and a plurality of edges, each edge connecting two vertices and having a weight indicative of a transaction volume performed between the entities represented by the vertices connected by that edge. A “transaction value” may refer to a digital asset and/or currency value, such as a cryptocurrency value. The weight may be indicative of one or more of: a total currency value transferred, and a total number of transactions. The edges may be undirected. The adjacency matrix may be a symmetric matrix.

Network entities may be associated with transaction participants. Each vertex may correspond to an identifier associated with a transaction participant, a cluster of identifiers, or an account of a transaction participant. Transaction participants may include (cryptocurrency) token owners identified by one or more identifiers such as blockchain addresses. Identifiers may comprise addresses, preferably blockchain addresses, controlled by users of the transaction network.

More generally, “network entities” can include any entities involved in transactions, e.g. associated with transaction sources/destinations, for example users/user identifiers, (blockchain) addresses, accounts/account identifiers, network nodes, etc.

Each vertex may correspond to a cluster of identifiers. Generating the transaction graph may comprise grouping identifiers (e.g. addresses) used as inputs for the same transactions to form a plurality of clusters. Generating the transaction graph may include aggregating transaction information associated with the identifiers of each cluster of identifiers. Each edge connecting two vertices may have a weight indicative of a total transaction volume performed between each combination of entities associated with the identifiers of the corresponding clusters. The method may further comprise calculating, for each pair of identifiers, clusters of identifiers or accounts: a total currency value transferred or a total number of transactions performed based on the transaction information.

The method may further comprise converting binary data of the transaction information into a human-readable format. The transaction network may be a distributed ledger network for recording transactions for transfer of digital assets. The distributed ledger network may be a blockchain network. The digital assets may be a transaction-based or an account-based cryptocurrency.

The anomaly may be price manipulation. The anomaly may be cryptocurrency price manipulation. Generating the detection output may comprise generating an output identifying one or more or all of the identified dense subgraphs to a user. The detection output may identify one or more the identified dense subgraphs to the user via an application or web interface. Generating the detection output may comprise: analysing the transaction information corresponding to the identified dense subgraphs to determine whether each dense subgraph is representative of a potential anomaly; and generating an output identifying the dense subgraphs which are determined as being representative of a potential anomaly. Analysing transaction information may comprise, for each identified dense subgraph: analysing the transaction information corresponding to the dense subgraph, comparing the analysed transaction information to historical currency price information, and verifying, based on the comparison, whether the transaction information of the dense subgraph is indicative of a potential anomaly. Analysing the transaction information corresponding to each dense subgraph may include determining a transaction frequency, a number of entities and/or a timing of relevant transactions.

The method may be performed by at least one computing device incorporating or connected to the GBS device. The method may further comprise filtering the outputs of the GBS device based on the size of the corresponding subgraphs, such that the identified dense subgraphs have significantly fewer vertices than the transaction graph. Filtering the outputs may comprise excluding outputs which correspond to subgraphs including more than a threshold number of vertices. The threshold number of vertices may be around 5%, 1% or 0.1% of the total number of vertices in the transaction graph.

The method may comprise repeating the steps of encoding inputs and processing outputs of the GBS device to identify dense subgraphs for each of a plurality of subgraphs of the transaction graph. This can enable dense subgraphs to be identified across a whole graph when the total number of vertices in the graph is greater than the maximum number of outputs of the GBS device. The method may comprise randomly selecting the plurality of subgraphs.

There is also disclosed herein a method of encoding the transaction data of a selected cryptocurrency into a quantum GBS device. The method includes constructing a transaction graph from the transaction data, the adjacency matrix of which is decomposed into a diagonal (D) and unitary (U) matrix according to the Autonne-Takagi factorization. Diagonal elements of D are programmed as squeezing parameters controlling the degrees of squeezing of the input states in a quantum GBS device. The unitary matrix U is programmed using an optical interferometer in a quantum GBS device, which transforms the input states into the output states.

There is also disclosed herein a method of detecting price manipulation in a transaction network using a GBS quantum device. A data collection procedure may collect transaction data from a distributed ledger of a transaction network, such as a blockchain. A pre-processor may transform the collected raw data into a form that is suitable for graph construction. A graph constructor may construct a graph based on the collected raw data and then may output an adjacency matrix for the constructed graph and the corresponding Autonne-Takagi factorization of the adjacency matrix. The Autonne-Takagi factorization of the adjacency matrix may include a diagonal matrix and a unitary matrix, and it may be output by the graph constructor in the form of a diagonal matrix (or a vector of diagonal elements of the diagonal matrix) and a unitary matrix. Alternatively, the Autonne-Takagi factorization may be output by the graph constructor in any other suitable form, such as a vector or an indexed series of values corresponding to the elements of the diagonal and unitary matrices. A programmable GBS device may be programmed to encode the adjacency matrix for performing the GBS. Outputs from the GBS device may be analysed by an analysis algorithm to generate dense subgraphs, which are detected as the potential groups of network nodes (e.g. transaction participants, devices or other actors) involved in price manipulation. An investigation component or subsystem (e.g. automated or based on human interaction) may investigate each detected dense subgraph for price manipulation.

There is also disclosed herein a system for detecting an anomaly in a transaction network using a quantum-computing device, comprising: means for obtaining transaction information of transactions performed between entities of the network; means for generating a transaction graph based on the transaction information; means for encoding inputs of a Gaussian Boson Sampling, GBS, device based on the transaction graph; means for processing outputs of the GBS device to identify one or more dense subgraphs of the transaction graph; and means for generating a detection output identifying one or more of the identified dense subgraph(s) as representative of a potential anomaly.

The system may further comprise means for performing the steps of any method described herein.

There is also described herein apparatus for detecting an anomaly in a transaction network using a quantum-computing device, comprising:
a Gaussian Boson Sampling, GBS, device comprising a photon source, a linear optical interferometer configured to scatter photons generated by the photon source, and a photon detector configured to detect photons output by the interferometer; and
a computer system communicably connected to the GBS device and configured to program inputs of the GBS device to control the photon source and interferometer based on information derived from a transaction graph;
wherein the computer system is configured to generate the transaction graph based on transaction information of transactions performed between entities of the network.

The computer system may be configured to perform the steps of any method described herein.

There is also described herein a computer program, computer program product or computer readable medium comprising software code adapted, when executed by a computer system, to perform any method described herein.

Any system or apparatus feature as described herein may also be provided as a method feature, and vice versa. As used herein, means plus function features may be expressed alternatively in terms of their corresponding structure.

Any feature in one aspect of the invention may be applied to other aspects of the invention, in any appropriate combination. In particular, method aspects may be applied to system or apparatus aspects, and vice versa. Furthermore, any, some and/or all features in one aspect can be applied to any, some and/or all features in any other aspect, in any appropriate combination.

It should also be appreciated that particular combinations of the various features described and defined in any aspects of the invention can be implemented and/or supplied and/or used independently.

### BRIEF DESCRIPTION OF THE FIGURES

Certain embodiments of the invention will now be described by way of example only, in relation to the Figures, wherein:

FIG. 1 illustrates a method for detecting an anomaly in a transaction network;

FIG. 2a illustrates functional components of an example system for detecting an anomaly in a transaction network;

FIG. 2b illustrates a system architecture of a system for detecting an anomaly in a transaction network;

FIG. 2c illustrates an example GBS device;

FIG. 3 illustrates different types of transaction graphs;

FIG. 4 illustrates how an adjacency matrix is obtained from a transaction graph;

FIG. 5 illustrates the encoding of a matrix into a GBS device;

FIG. 6 illustrates how dense subgraphs are identified and verified.

### DETAILED DESCRIPTION

Processing a transaction (e.g. a cryptocurrency transaction) in a transaction network, such as distributed ledger system (e.g. a blockchain), is a peer-to-peer (P2P) process whereby a transaction request is broadcast to all nodes in the network and then recorded to the distributed ledger (a blockchain) if confirmed. Transaction networks can be analysed using graph (network) methods by representing transaction information in a graph and then extracting properties or quantities by analysing the graph. This can provide both static and dynamic information about the transaction network including the detection of abnormal or illicit activity. The following passages discuss an example in the context of cryptocurrency transaction networks, but the principles may be applied to other types of transaction networks, and more generally to any network involving exchanges of messages, events or transactions between nodes (e.g. devices, users, or other actors).

When representing transaction data in a graph, vertices and edges are chosen based on the transaction model of the specific transaction network and/or cryptocurrency. Two different types of transaction models are commonly adopted among cryptocurrencies: in transaction-based systems such as blockchain systems (e.g. Bitcoin), a single transaction can have multiple inputs and outputs (e.g. in the form of unspent transaction outputs or other tokens which are typically associated with an identifier of a token owner such as a blockchain address), while in account-based systems such as Ethereum each transaction has only one input and one output (e.g. specifying a transfer of a transaction value between two accounts identified by account identifiers).

In preferred embodiments, for transaction-based systems, the present system constructs graphs using transactions, addresses, and/or users as vertices, and edges are constructed and weighted according to the amount of cryptocurrency traded by such transactions, addresses and/or users. For example, if one or more transactions exist between two addresses or users, an (undirected) edge can be constructed between vertices representing those addresses/users, and the edge can be weighted according to the total cryptocurrency value of those transactions.

For account-based systems, preferred embodiments use vertices corresponding to accounts and edges are weighted by cryptocurrency flow between those accounts. Two different kinds of accounts are commonly used, namely externally owned accounts (EOA) and contract accounts.

The system can use different measures to quantify various properties of constructed transaction graphs for extracting meaningful information on the transaction network. For example, degree distribution measures the probability distribution of vertex degree (number of edges incident to the vertex) in a graph, which often follows a power law e.g. with path distance or graph size. Portions or subgraphs of the constructed transaction graph that have dense internal connections but sparse external ones are identified, and can be used to analyse the transaction network.

Classical polynomial algorithms exist for solving the problem of finding dense subgraphs of a general graph, but the so-called densest k-subgraph (Dks) problem in general is NP-hard. The Dks problem is defined as follows: given a n-vertex graph G, find the subgraph of k vertices with the highest density. The density of a subgraph can be defined as a ratio between the number of edges present and a maximum number of possible edges between the vertices of the subgraph. Alternatively, the density of a subgraph may be some other parameter indicative of a ratio between the number of edges, a possible number of edges, and the number of vertices in the subgraph. Additionally or alternatively, the density of a subgraph may be based on the weights of the edges within that subgraph. For example, a subgraph with a higher ratio of the number of edges and/or sum of edge weights to the possible number of edges and/or the number of vertices can correspond to a higher subgraph density.

Embodiments of the invention use a quantum computing device to analyse constructed transaction graphs, specifically to tackle the Dks problem. In preferred embodiments, the quantum computing device is a Gaussian boson sampling (GBS) device. A GBS device is an optical quantum computing system performing the task of GBS, where single photons are sampled from a many-mode Gaussian state and the probability of obtaining a specific sampling result depends on the hafnian function of the covariance matrix of the Gaussian state. The modes of the Gaussian state refer to Gaussian probability distributions in the phase space, which can also be viewed as a superposition of different Fock states, or in other words, quantum states with different photon numbers.

The GBS device includes a programmable photon source, a linear optical interferometer and multiple single-photon detectors. The photon source (input) of the GBS device is capable of generating an n-mode Gaussian state, which is programmable via n squeezing parameters. The squeezing parameters change for each state the Gaussian parameters of the corresponding input mode. The linear interferometer scatters photons generated by the photon source via linear interference using beam splitters, the reflectivity and transmissivity of which are programmable. In particular, the reflectivity and transmissivity of the beam splitters can be defined by a unitary matrix. The output of the GBS device includes n single-photon detectors, each of which can detect either a single photon scattered by the interferometer or nothing. In particular, the detectors produce an output O=(o₀, o₁, . . . , oₙ), where oᵢ=0 or 1 indicating whether a single photon has been detected at the i^{th} single-photon detector.

The methods and apparatus described herein illustrate that the quantum computational advantage of a GBS device can be used to provide efficient and accurate detection of abnormal activity in transaction networks such as price manipulation.

The illustrative embodiments presented here generally are used for the purpose of addressing the problem of identifying abnormal activity (e.g. price manipulation) in a transaction network. However, it will be appreciated that the techniques described can be used for identifying abnormal activity in other types of network, such as communication, computing, social or search engine networks.

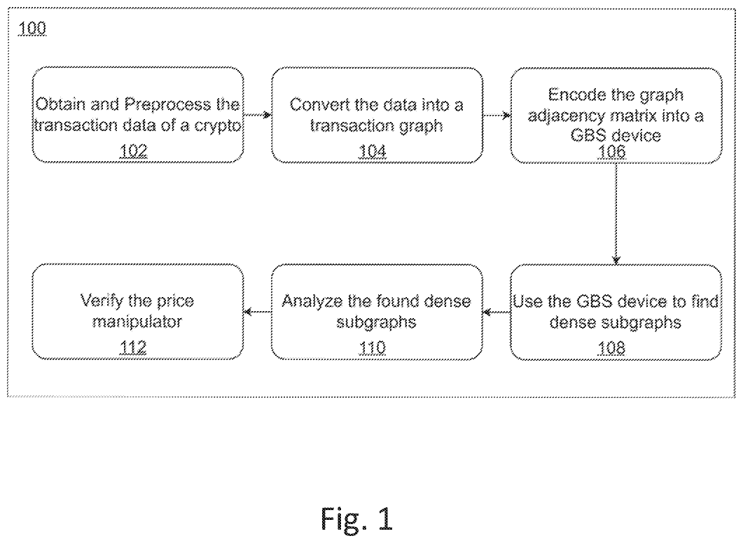

Referring to FIG. 1, a method 100 for analysing a transaction network will now be described. The method begins at step 102 by obtaining and pre-processing transaction data of a cryptocurrency transaction network. The transaction data can be obtained directly from a distributed ledger (e.g. a blockchain), or can be read from memory having been obtained from the distributed ledger previously. For example, transaction data may be obtained directly from a distributed ledger periodically and stored in memory (e.g. at a server), and a portion of those transaction data (e.g. transactions corresponding to a predetermined period of time) may be retrieved from the memory and used in the method 100. Although the transaction data of distributed ledger systems (such as blockchains) are accessible to the public, the raw data recorded in the ledgers are often in binary format and may thus first be converted into a human-readable format. Accordingly, a data collector, parser, client, or block explorer service can be used to convert the data into a human-readable format.

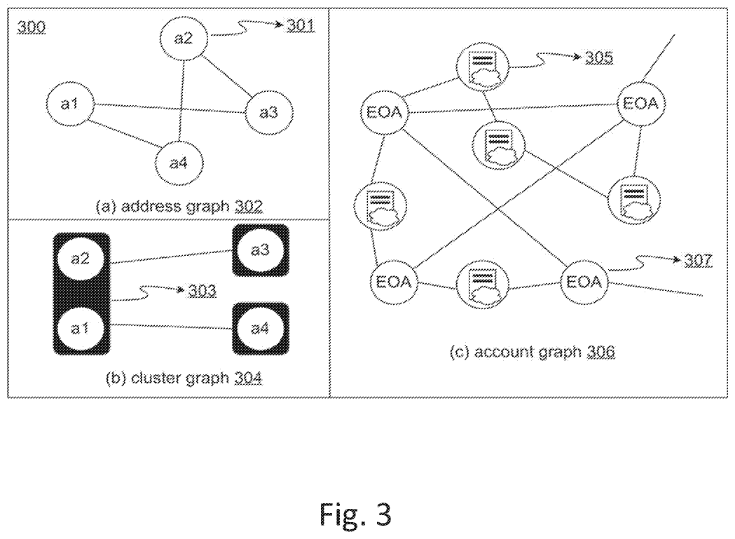

At step 104, a graph G with vertices and edges is constructed based on the transaction data. The definition of a vertex depends on the type of transaction network or system (e.g. whether it is account-based or transaction-based), which will be discussed further with reference to FIG. 3. An edge exists when two vertices have transaction records. Each vertex in the graph G may represent an address, a cluster of addresses, or an account. An address may e.g. be a blockchain address or similar and may be associated with or identify a user or transaction participant. For example, in token-based blockchain networks, an address may represent an owner of a cryptocurrency token used as input/output of a transaction. Other types of identifiers may be used in place of (blockchain) addresses. Two kinds of weights can be assigned to edges, namely the total transaction volume or the total transaction number, where the total transaction volume corresponds to the total volume (or cryptocurrency value) of all transactions between two addresses, clusters of addresses or accounts (represented by vertices), and the total transaction number corresponds to the total number of transactions between the two addresses, clusters or accounts. Where vertices represent a cluster of identifiers such as addresses, transaction information associated with the identifiers of each cluster may be aggregated when generating the transaction graph. For example, the weight of each edge connecting two vertices (each representing a cluster of addresses) may be indicative of a total transaction volume performed between each combination of entities associated with the individual identifiers of the two clusters, e.g. such that the total transaction volume is based on transactions involving a portion of the clustered identifiers as well as transactions involving all of the clustered identifiers.

At step 106, a graph adjacency matrix A of the graph G is encoded for input into a GBS device. Specifically, the adjacency matrix A of the constructed graph G is determined and decomposed into a diagonal matrix (D) and a unitary matrix (U), e.g. according to the Autonne-Takagi factorization. The matrices D and U are then provided as input to a GBS device.

An adjacency matrix A of a graph is constructed in the following way:

$${A}_{ij} = \{ \begin{matrix}{ω}_{ij} & if an edge exists \\ 0 & if i = j or no edge exists\end{matrix} \} , \qquad ( Equation 1 )$$

where i,j refer to vertices, Aᵢⱼ is the matrix element of the adjacency matrix A, and ωᵢⱼ is the edge weight if an edge exists between i and j. Where the graph G is an undirected graph, the adjacency matrix A is therefore symmetric. The encoding of matrix A into a GBS device generally depends on the so-called Autonne-Takagi factorization of a symmetric matrix A, A=U*DU^{†}, where U is an unitary matrix and D is a diagonal matrix, and U* represents the conjugate of U and Ut represents the conjugate transpose of U. Thus, adjacency matrix A is factorized according to this factorization to determine the diagonal matrix D and unitary matrix U.

At step 108, the GBS device is used to find dense subgraphs of the transaction graph G. This includes performing Gaussian Boson Sampling (GBS) multiple times using the GBS device based on the input encoding of the adjacency matrix A, identifying outputs of the GBS device corresponding to high probabilities or rates of occurrence, and determining the corresponding subgraphs. In some examples, the diagonal elements of diagonal matrix D are used to program squeezing parameters of the GBS device in order to control the degrees of squeezing of the input states of the GBS device. Optionally, the diagonal elements of matrix D may be rescaled (e.g. between 0 and 1) before being used to program the squeezing parameters. The unitary matrix U can be used to program a linear interferometer of the GBS device. Therefore, the photon source generates an n-mode quantum state having an n-mode Gaussian probability distribution, and the programming of squeezing elements using diagonal matrix D results in the n phase-space distributions being stretched. The overall distribution is further modified according to the unitary matrix U via the interferometer, resulting in a final distribution according to which the n single-photon detectors detect photons.

The densities of the found subgraphs are high because the probability of obtaining a GBS output corresponding to a given subgraph is proportional to the number of perfect matchings in that subgraph, and more perfect matchings corresponds to more edges in the subgraph. In other words, if a given subgraph has a higher number of subsets of edges which are incident with every vertex in that subgraph (number of perfect matchings, corresponding to the hafnian of the adjacency matrix of that subgraph) and is thus relatively dense, the probability of the GBS device producing an output corresponding to that subgraph is higher. This is because the photon source and linear interferometer of the GBS device are programmed using the unitary and diagonal matrices which themselves are derived from the adjacency matrix of the graph, and the probability of the GBS device outputting a specific pattern is proportional to the number of perfect matchings (and thus the hafnian) of the corresponding subgraph. Therefore, the modal outputs of the GBS device can be used to identify dense subgraphs. Since the hafnian of a subgraph depends on the adjacency matrix of that subgraph, the hafnian also depends on edge weights in the subgraph. For example, a subgraph with larger edge weights will in general result in a higher hafnian of that subgraph's adjacency matrix. Accordingly, denser subgraphs will have higher hafnians (than less dense subgraphs), so regions of the diagonal and unitary matrices D and U which correspond to a dense subgraph will have higher values. Therefore, by controlling the squeezing of the photon source using matrix D and the scattering of the linear interferometer using matrix U, photons are more likely to be detected for modes which correspond to vertices of the dense subgraph. This results in the single-photon detectors producing an output photon pattern corresponding to the dense subgraph.

Outputs are sampled from the GBS device many times, and those which occur often are considered to correspond to dense subgraphs of the graph G. For example, an observed probability distribution can be constructed from the obtained samples and subgraphs corresponding to the modal value(s) of the distribution can be selected for analysis. In some examples, the GBS device may be used to obtain at least around 10⁷ samples, or at least around 10⁸ samples, preferably at least around 10⁹ samples or 10¹⁰ samples. In some examples, the GBS device may sample photons at a rate of at least around 100 kHz, or at least around 1 MHz, preferably around 1 GHz. The photons may be sampled using the GBS device for at least around 100 seconds, or at least around 1,000 seconds, preferably around 10,000 seconds. In some examples, following the sampling, a predetermined number or proportion of GBS outputs (corresponding to subgraphs) are selected for analysis, such as the top 5, 10, 50 or 100 most common outputs, or the top 1%, 0.5%, 0.1%, 0.01% or 0.001% of outputs (when ranked by probability/occurrence).

Steps 110 and 112 involve analysing the subgraphs found at step 108 to verify the transaction activity represented by those subgraphs, e.g. to detect if price manipulation has occurred. Analysing the subgraphs can include: checking if vertices correspond to transactions, addresses or clusters of addresses; and comparing transaction activity to information obtainable from the transaction system or other public data source, e.g. verifying if buying and selling of a cryptocurrency occurred among a few vertices before the price of that cryptocurrency went up, indicating a risk of “Pump and Dump” manipulation, or verifying if fast buying and selling of a cryptocurrency among a small group of vertices corresponded to a change in price for that cryptocurrency in a short period, indicating a risk of “Wash Trading”.

In some examples, analysing the dense subgraphs to verify transaction activity can include analysing corresponding transaction information to determine whether each dense subgraph indicates a potential network anomaly or abnormal activity. For example, analysing the transaction information can include determining a frequency of one or more transactions, determining a number of entities involved in the relevant transactions, and/or determining a timing of the relevant transactions (e.g. a time of day, date and/or relative timing to another event). Analysing the transaction information can also include comparing the transaction information to historical currency price information, and verifying based on the comparison whether a potential anomaly is present. For example, the transaction information (e.g. raw transaction data and/or the determined frequency/timing/number of entities) can be compared to past events such as rises or falls in the price of a particular (crypto) currency.

In some examples, the analysis and verification at steps 110 and 112 may be performed automatically, for example automated, rule-based analysis may be performed based on the users, timing and/or value of transactions. Alternatively, following step 108 the GBS results corresponding to dense subgraphs may be output to a user for user analysis according to steps 110 and 112. For example, the results may be provided to a user via a web interface being run on a user/client device.

Steps 108 to 112 thus enable the linking of output results of a quantum GBS device to a pattern of abnormal activity in a transaction network, such as price manipulation of a cryptocurrency. Since transaction network actors exhibiting abnormally high levels of activity (e.g. performing price manipulation) form a dense subgraph of the constructed transaction graph and the probability of obtaining an output (corresponding to a subgraph) from a quantum GBS device is positively correlated to the density of the subgraph, output results from the quantum GBS device with high probabilities correspond to potential groups of nodes exhibiting abnormal activity (e.g. performing price manipulation).

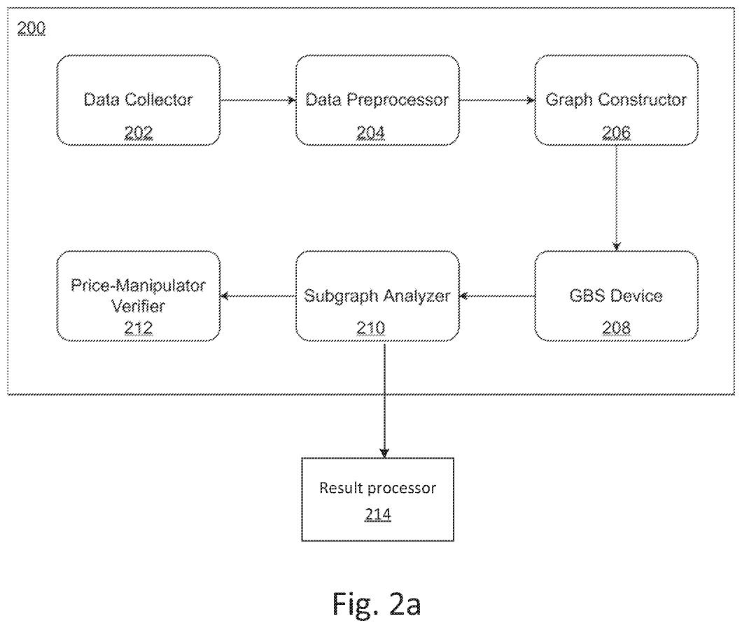

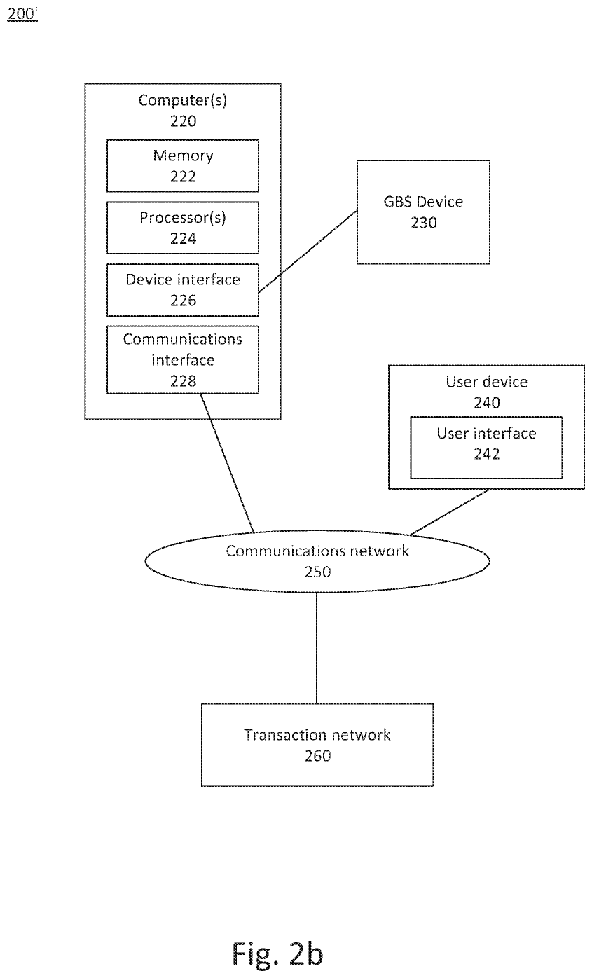

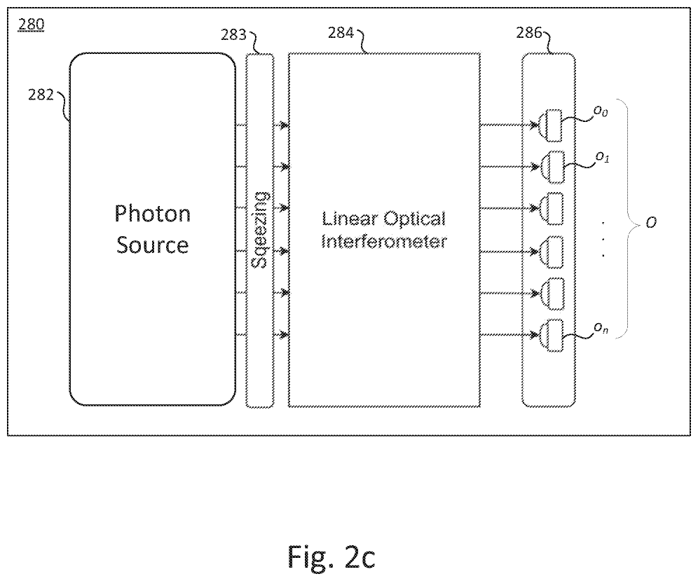

FIG. 2a depicts an example system 200 of modules for implementing the method 100. The system 200 includes six functional parts: a data collector 202 collects data either directly from a transaction network (e.g. the underlying blockchain system of a cryptocurrency) or from an existing parser, client, or block explorer service providing human-readable data sets. A data pre-processor 204 pre-processes the collected transaction data, comprising converting binary data into a human-readable form if applicable and calculating the transaction volume and number for every vertex pair, where vertices are either addresses, clusters of addresses, or accounts. The data collector 202 and/or data pre-processor 204 may be configured to perform step 102 of the method 100 described above. A graph constructor 206 converts the transaction data into a transaction graph, where vertices and edges are constructed according to step 104 in FIG. 1. A GBS device 208 (e.g. as described above) is configured to perform the GBS task. A subgraph analyser 210 is configured to analyse the obtained subgraphs from the GBS device, including selecting subgraphs with high densities. In cases where the analysis and verification of dense subgraphs (e.g. according to steps 110, 112) are performed automatically, the subgraph analyser 210 may be configured to perform the step 110 described above, and the system 200 may further include a verifier 212 (e.g. a price-manipulation verifier) which verifies any identified abnormal transaction activity (e.g. if price manipulation has occurred). In cases where the analysis and verification of dense subgraphs (e.g. according to steps 110 and 112) are performed by a user, the system may not include a price-manipulator verifier 212, but instead includes a GBS result processor 214 configured to provide the selected dense subgraphs to a user in a human-readable format.

In some examples, the data collector 202, data pre-processor 204, graph constructor 206, subgraph analyser 210, verifier 212 and/or result processor 214 are implemented as software modules on one or more computers. In this case, the GBS device 208 is integrated into, or communicatively coupled, e.g. via a wired connection, wireless connection or communications network, to at least one of the computers on which the other modules are implemented. The system 200 may be implemented as a networked computing system.

FIG. 2b illustrates an example system 200′, which in some examples is used for implementing the system 200 of FIG. 2a. The system 200′ includes one or more computers 220, comprising a memory 222, at least one processor 224, device interface 226 and communications interface 228. The system 200′ also includes a Gaussian Boson Sampling (GBS) device 230 and a user device 240. At least one of the computer(s) 220 is configured to communicate directly with the GBS device 230 via the device interface 226, e.g. via a wired connection or a wireless connection. In alternative embodiments (not shown), the computer(s) is configured to communicate with the GBS device 230 via a communications network, such as communications network 250.

At least one of the computer(s) 220 is configured to communicate with the user device 240 via the communications interface 228 of the computer(s) and a communications network 250. The user device 240 is configured to display outputs to and receive inputs from a user via a user interface 242, e.g. a web browser, to allow the user to control the analysis process and view/process results of the analysis. At least one of the computer(s) 220 is configured to communicate with a transaction network 260 via the communications interface 228 and the communications network 250. The transaction network 260 may be a distributed ledger system, such as a blockchain-based distributed ledger system.

In some examples, the computer(s) 220 is configured to receive transaction data from the transaction network 260 via the communications interface 228 and store the transaction data in memory 222. Accordingly, the computer(s) 220 can implement the data collector 202 of FIG. 2a. Similarly, the computer(s) 220 (e.g. using the memory 222 and processor(s) 224) can implement the data processor 204, graph constructor 206, subgraph analyser 210, verifier 212 and/or result processor 214 of FIG. 2a. For example, once dense subgraphs (or candidate dense subgraphs) are determined by the computer(s) 220 based on the output of the GBS device 230 and converted to a human-readable format, they can be transmitted by the computer(s) to the user device 240 via the communications interface 228 and network 250.

In some examples, the computer 220 (or one of them if the system is implemented by multiple devices) is itself a node (e.g. blockchain node) of the transaction network 260 and may thus be able to directly read transaction data from the blockchain.

FIG. 2c illustrates an example GBS device 280, such as GBS devices 208, 230 shown in FIGS. 2a and 2b. The GBS device 280 includes a photon source 282, a linear optical interferometer 284, and a photon detector 286. The photon source 282 (input) of the GBS device 280 generates n input modes and photon detector 286 (output) has n single-photon detectors which produce n binary output signals o, to on, and which correspond to the n-mode squeezed Gaussian-state inputs generated by the photon source 282. The photon source 282 is programmable via squeezing parameters 283 to change corresponding Gaussian parameters of the input states. The linear interferometer 284 scatters photons generated by the photon source 282 using beam splitters, the reflectivity and transmissivity of which are programmable. The photon detector 286 detects and counts incident photons scattered by the interferometer 284. In particular, the detector produces an output O=(o₀, o₁, . . . , oₙ), where oᵢ=0 or 1 indicating whether a single photon has been detected.

FIG. 3 depicts three different types of graphs that may be constructed from the transaction data. In some examples, a graph-type selector 300 can be used in the system 200 before the graph constructor module 206 in FIG. 2a, which selects a graph type to be constructed based on the collected transaction data. The graph types include: an address graph 302 where vertices represent addresses 301; a cluster graph 304 where vertices represent address clusters 303; and an account graph 306 where vertices represent accounts, such as externally-owned accounts (EOA) 305 and contract accounts 307. Address and account graphs 302 and 306 are used for transaction-and account-based systems, respectively, while cluster graphs 304 are used when reduction of the problem complexity is needed, for example if the transaction dataset is too large or the available GBS device is not powerful enough to handle large-scale data. Cluster graphs are only created for transaction-based systems and may be defined according to the following rule: addresses that are used as inputs of the same transactions form one cluster.

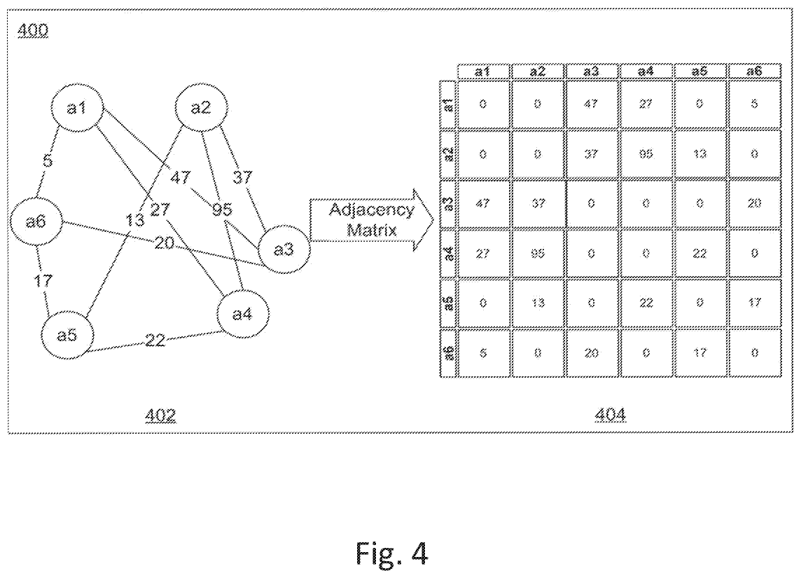

FIG. 4 depicts how to construct the adjacency matrix 404 of an example transaction graph 402 according to Equation 1, e.g. when performing step 104 of the method 100. The adjacency matrix 404 is constructed such that each matrix element Aᵢⱼ is non-zero if an edge exists from vertex i to vertex j in the graph 402 constructed from the transaction data. The value of each adjacency matrix element corresponds to the weight of the corresponding edge. For example, with reference to FIG. 4, in the graph 402 an edge exists between vertex a1 and vertex a3 and has a weight of 47. The corresponding element of the adjacency matrix 404 (row 1, column 3) has a value of 47 accordingly. In cases where the graph 402 is an undirected graph, the adjacency matrix will thus be a symmetric matrix (with elements of its leading diagonal equal to zero).

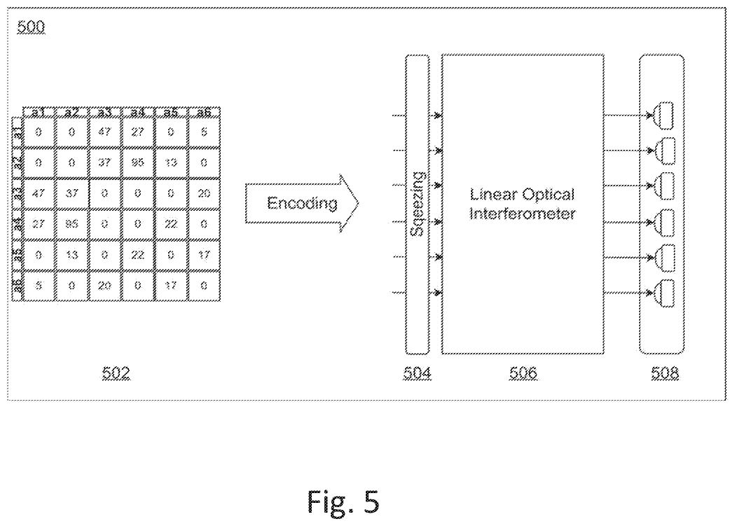

FIG. 5 depicts schematically an example of encoding a symmetric matrix 502 into a GBS device (such as GBS device 208, 230 or 280), e.g. when performing step 106 of the method 100. Operation of the GBS device comprises three different aspects: a squeezing operation 504, operation of the linear optical interferometer 506, and detecting photons using detectors 508. As described above, the encoding is based on the Autonne-Takagi factorization, where the diagonal matrix D and unitary matrix U are applied to stages 504 and 506, respectively. The squeezing 504 transforms the degree of squeezing of the input states according to the diagonal matrix D, whereby the elements of D (which may be rescaled first) act as squeezing parameters for each input mode, changing the corresponding Gaussian parameters. In particular, the squeezing parameters describe how the Gaussian probability distributions of the input states are stretched in the phase space, and determine the photon number and phase distribution of these input Gaussian modes. The phase distributions impact the performance of the linear interferometer and the photon detectors of the GBS device. The linear optical interferometer 506 is composed of beam splitters whose reflectivity/transmissivity are programmable. The operation of a linear optical interferometer is controlled by the unitary matrix U obtained by the factorization, the elements of which define the reflectivity/transmissivity of the beam splitters. The outputs of the GBS device are collected from 508, where single photons are detected and counted.

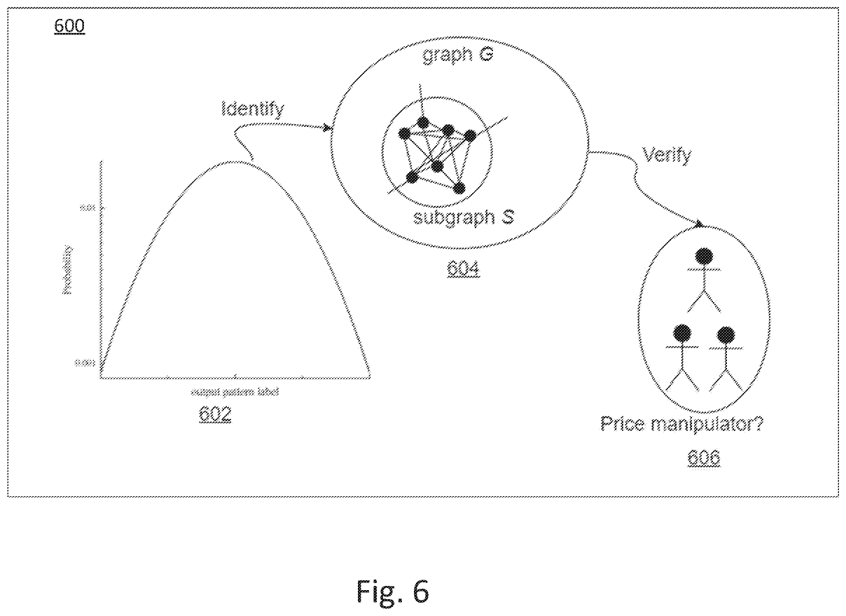

FIG. 6 depicts how to use the output from a GBS device to detect price manipulation in the crypto market. The probability distribution 602 is obtained from the sampling output. A n-mode GBS device has an output O=(o₀, o₁, . . . , oₙ), where oᵢ=0 or 1 when a single photon is or is not detected. The value of n can be at least around 100, though in some embodiments higher values of n may be used, e.g. at least 10³ or 10⁶. Different combinations of oᵢ (i=0, 1, . . . , n) form different output patterns and have different probabilities of being detected. Each output oᵢ can be mapped to a single vertex in the constructed transaction graph. For example, the modes (and thus outputs oᵢ) can be mapped to vertices in the transaction graph in the same order that the vertices are mapped to indices of the adjacency matrix. Accordingly, once the transaction graph has been constructed, the GBS device is set to have the same number of modes as there are vertices in the graph, and thus each input mode and output of the GBS device correspond to a respective vertex in the transaction graph. The following description assumes that the number of vertices in the graph is less than or equal to n (number of modes/outputs). Approaches where the graph is larger than can be analysed by the GBS device in a single operation (number of vertices exceeds n) are described further below.

By identifying the k non-zero elements of the output O, a subgraph (subset of the vertices of the constructed transaction graph) with the corresponding k vertices can be determined. By using the unitary and diagonal matrices resulting from the Autonne-Takagi factorization of the adjacency matrix of the transaction graph, the GBS device thus samples outputs (corresponding to subgraphs) with a probability according to the hafnian of the adjacency matrix. Since the hafnian is positively correlated to the subgraph density, the subgraphs corresponding to GBS device outputs are therefore more likely to be dense transaction subgraphs. By iterating to generate many output samples, a probability distribution 602 (e.g. defining estimated probabilities of observing different output patterns, which may be identified by output pattern labels) is determined, and the outputs with the highest probability/occurrence correspond to the densest subgraphs.

For example, a GBS output pattern with a relatively high probability can be used to directly identify a subgraph S with a high density from the transaction graph G, shown as block 604 in FIG. 6. In one example, a single subgraph S may be selected, having the highest observed probability. In other examples, multiple subgraphs having high probabilities may be selected (e.g. a selected number of highest-probability output patterns could be chosen, or all output patterns with a probability exceeding a predetermined threshold). For a given selected output pattern, the identified dense subgraph S is given by the set of vertices corresponding to the elements of the output O having a value of Oₓ=1 (corresponding to detection of a photon), in accordance with the mapping between output elements and graph vertices. Vertices with corresponding output values of Oₓ=0 are not part of the dense subgraph.

If the graph has more vertices than the maximum number of GBS device outputs n, the described approach can be modified by repeated sampling of the whole graph, with the GBS analysis applied to subgraphs of (up to) n vertices from a total number of m vertices of a much larger graph (e.g. typically n<<m). Each application of the GBS algorithm thus processes a sampled subgraph to identify dense subgraphs within the sampled subgraph. Sampling may be random, and the sampling is repeated a certain number of times to ensure sufficient coverage of the whole graph. Alternatively, the GBS process can be repeated over different systematically selected n-vertex portions of the graph, e.g. a sliding window-type approach may be used to identify and analyse dense subgraphs within an n-vertex portion of the transaction graph, then repeat the analysis for a different (preferably overlapping) n-vertex portion of the transaction graph.

As a further alternative, when the number of nodes in the graph is greater than the value of n, classical cluster detection algorithms can be combined with the GBS method described herein. For example, a cluster detection algorithm can be used to detect portions of the graph having vertex numbers (total number of vertices or nodes) less than or equal to n, and then the GBS approach described herein can be performed for each of those identified portions of the graph to identify dense subgraphs therein.

After a dense subgraph is found, the existences of abnormal network activity, e.g. price manipulation activities of “Pump and Dump” and “Wash Trading”, are verified at block 606. Accordingly, in some examples, the approach of FIG. 6 may be used to implement the steps 108-112 of method 100.

In some examples, dense subgraphs are presented to a user with relevant transaction information, such as the addresses and/or accounts of the corresponding vertices, and the transaction amounts. In some examples, the raw transaction data corresponding to the vertices of the identified dense subgraph can also be presented to the user. Based on the dense subgraph and relevant transaction information, the user can investigate transactions. Alternatively, once dense subgraphs are identified, an automatic analysis (e.g. using a computer program) can be performed to evaluate the subgraph and generate an indication and/or likelihood that abnormal or illicit network activity, such as price manipulation, has occurred within the subgraph.

Once abnormal network activity (e.g. price manipulation) has been identified, one or more mitigating steps may be performed. For example, in the case of transaction networks, identifying information of the owners of the addresses/accounts corresponding to vertices of the dense subgraph may be determined to allow e.g. regulatory action to be initiated.

Embodiments of the invention may provide the following features.

While the described techniques are more widely applicable, certain embodiments can provide a method for detecting two specific types of price manipulations in the cryptocurrency market i.e., “Pump and Dump” and “Wash Trading”, using an optical quantum-computing device. In some embodiments, the method comprises six different steps: (a) obtaining and pre-processing transaction data of a cryptocurrency from the underlying blockchain system or other resources, (b) converting the data into a transaction graph, (c) encoding the adjacency matrix of the transaction graph into a GBS device, (d) performing GBS to identify dense subgraphs, (e) analysing the obtained dense subgraphs, and (f) verifying the existence of the types of price manipulations.

The method may be implemented using a data-processing structure comprising six different function units, i.e., a data collector, a data pre-processor, a graph constructor, a GBS device, a subgraph analyser, and a price-manipulator verifier. Constructed graphs in the method may be undirected, edges of which are weighted by either the total transaction volume or the total transaction number between any two connected vertices. Constructed graphs in the method may be one of three different types: address, cluster, or account graph. According to the transaction model of the cryptocurrency, for transaction-centred cryptocurrencies an address or cluster graph is used, while for account-centred cryptocurrencies the account graph is chosen. In the first case, if complexity reduction is needed, for example the total dataset is too large for the current state-of-the-art GBS devices, the cluster graph is used instead of the address one. Clusters in a cluster graph may be clusters of different addresses used as inputs of same transactions.

The pre-processing of raw data may comprise: (a) converting binary data into human-readable forms if applicable, (b) calculating total transaction volume and number for every vertex pair, and (c) identifying clusters of addresses for data from transaction-centred cryptocurrencies if applicable.

The adjacency matrixes of graphs may be symmetric and the encoding into a GBS device depends on the so-called Autonne-Takagi factorization, where a diagonal and unitary matrix are implemented by a squeezing operation and linear interference, respectively, in the GBS device. The outputs of GBS are collected by photon detectors and are collision-free, i.e. every output mode detects not more than one photon. The method may explore subgraphs with small number of vertices, k<<n, where n and k are the vertex number of the transaction graph and its subgraph.

It will be understood that the present invention has been described above purely by way of example, and modification of detail can be made within the scope of the invention.

For example, while described in relation to the example of detection of price manipulation in transaction networks, the described techniques can be used in other contexts that involve a network of nodes interacting with each other through transactions, communication exchanges or other events. For example, in a computer or communications network, communication flows may be analysed using the described techniques. Network nodes such as computers, servers, client devices, switches, routers etc. may be represented as vertices in the graph, with weights on graph edges set based on data flow volumes, connection/packet rates, packet drop rates or other traffic metrics. Dense subnetworks are then identified using the GBS device as previously described. The identified dense subgraphs can be analysed to determine if abnormal or unwanted network activity, such as packet congestion, transmission errors or other faults, or malicious activity such as denial-of-service attacks, have occurred. Mitigating steps can then be performed, such as re-routing traffic to avoid network congestion, quarantining nodes originating malicious traffic, reconfiguring firewall access rules and the like.

As mentioned, the techniques may also be applied to analysis of web link networks, social network graphs etc.

Although described in the context of optical GBS devices involving optical interferometers, in some examples, the GBS device can use bosons other than photons, and as such may more generally include any suitable programmable boson source, linear interferometer and multiple single-boson detectors.

1. A method of detecting an anomaly in a transaction network using a quantum-computing device, comprising:
obtaining transaction information of transactions performed between entities of the network;
generating a transaction graph based on the transaction information;
encoding inputs of a Gaussian Boson Sampling, GBS, device based on the transaction graph;
processing outputs of the GBS device to identify one or more dense subgraphs of the transaction graph; and
generating a detection output identifying one or more of the identified dense subgraph(s) as representative of a potential anomaly.

2. The method of claim 1, wherein processing outputs of the GBS device comprises mapping the outputs of the GBS device to vertices of the transaction graph to form subgraphs of the transaction graph.

3. The method of claim 1, wherein encoding inputs of the GBS device comprises:
generating an adjacency matrix of the transaction graph; and
encoding inputs of the GBS device based on the adjacency matrix.

4. The method of claim 3, wherein encoding inputs of the GBS device further comprises:
determining a unitary matrix and a diagonal matrix based on the adjacency matrix, wherein the unitary matrix and the diagonal matrix are optionally determined based on a factorization of the adjacency matrix; and
programming the GBS device based on the unitary matrix and diagonal matrix.

5. The method of claim 4, wherein the GBS device comprises a linear optical interferometer and preferably further comprises a photon source for supplying photons to the interferometer and a photon detector for detecting photons output by the interferometer.

6. The method of claim 5, wherein programming the GBS device comprises:
programming the linear interferometer based on the unitary matrix, preferably including controlling linear interference by programming the reflectivity and/or transmissivity of beam splitters of the linear interferometer using the elements of the unitary matrix; and/or
programming the photon source based on the diagonal matrix, preferably including setting squeezing parameters of the photon source based on diagonal elements of the diagonal matrix.

7. The method of claim 5, wherein the photon detector is configured to produce an output comprising a plurality of output signals, wherein each output signal is indicative of whether a single photon has been detected, and wherein each output signal is a binary output signal.

8. The method of claim 7, wherein each output signal corresponds to a vertex in the transaction graph.

9. The method according to claim 7, wherein each output signal indicates a positive result indicative of detection of a photon or a negative result indicative of absence of a detected photon, and wherein, for each photon detector output, a combination of the output signals which indicate a positive result corresponds to a subgraph of the transaction graph.

10. The method of claim 1, wherein processing outputs of the GBS device comprises processing a plurality of outputs over repeated operation of the GBS device, each output identifying a subgraph of the transaction graph.

11. The method of claim 10, further comprising, for each of a set of possible outputs corresponding to respective subgraphs, estimating a probability of detecting the output based on the plurality of outputs, and wherein identifying one or more dense subgraphs is based on the estimated probabilities.

12. The method of claim 11, wherein the probability of detecting the output is estimated based on the frequency with which the output is observed in the plurality of outputs.

13. The method of claim 11, wherein identifying one or more dense subgraphs comprises:
selecting one or more of the outputs of the GBS device having high estimated probabilities, optionally comprising one or more of:
selecting one or more outputs having probabilities exceeding a threshold; and
selecting a predetermined number of the outputs which have the highest estimated probabilities;
the method further comprising determining, for each selected output, a corresponding subgraph of the transaction graph to be a dense subgraph.

14. The method of claim 1, wherein generating the transaction graph comprises:
identifying a plurality of transactions based on the transaction information, each transaction indicative of network entities and a transaction value transferred between the network entities; and
generating a transaction graph comprising:
a plurality of vertices based on the network entities; and
a plurality of edges, each edge connecting two vertices and having a weight indicative of a transaction volume performed between the entities represented by the vertices connected by that edge.

15. The method of claim 14, wherein the weight is indicative of one or more of: a total currency value transferred, and total number of transactions.

16. (canceled)

17. The method of claim 14, wherein network entities are associated with transaction participants, and wherein each vertex corresponds to an identifier associated with a transaction participant, a cluster of identifiers, or an account of a transaction participant.

18. The method of claim 17, wherein identifiers comprise addresses, blockchain addresses, or both, controlled by users of the transaction network.

19. The method of claim 17, wherein each vertex corresponds to a cluster of identifiers, and wherein generating the transaction graph further comprises grouping identifiers used as inputs for the same transactions to form a plurality of clusters.

20. The method of claim 17, further comprising calculating, for each pair of identifiers, clusters of identifiers or accounts: a total currency value transferred, or a total number of transactions performed based on the transaction information.

21. (canceled)

22. The method of claim 1, wherein the transaction network is a distributed ledger network for recording transactions for transfer of digital assets, wherein the transactions comprise transactions involving a transaction-based or an account-based cryptocurrency.

23.-33. (canceled)
